(19) United States
(12) Patent Application Publication
(10) Pub. No.: US 2016/0195846 A1
(43) Pub. Date: Jul. 7, 2016

(54) DEVELOPING DEVICE AND IMAGE FORMING APPARATUS INCORPORATING SAME

(71) Applicants: Shinnosuke KOSHIZUKA, Kanagawa (JP); Koichi YAMAZAKI, Kanagawa (JP); Tatsuya KUBO, Kanagawa (JP); Atsushi NAKAMOTO, Kanagawa (JP); Teppei KIKUCHI, Kanagawa (JP); Kazunori SUZUKI, Kanagawa (JP); Naohiro KAWASHIMA, Kanagawa (JP)

(72) Inventors: Shinnosuke KOSHIZUKA, Kanagawa (JP); Koichi YAMAZAKI, Kanagawa (JP); Tatsuya KUBO, Kanagawa (JP); Atsushi NAKAMOTO, Kanagawa (JP); Teppei KIKUCHI, Kanagawa (JP); Kazunori SUZUKI, Kanagawa (JP); Naohiro KAWASHIMA, Kanagawa (JP)

(21) Appl. No.: 14/982,586

(22) Filed: Dec. 29, 2015

(30) Foreign Application Priority Data
Jan. 5, 2015 (JP) 2015-000427

(51) Int. Cl. G03G 21/20; G03G 15/08

(52) U.S. Cl. CPC G03G 21/20; G03G 15/0865

(57) ABSTRACT

A developing device includes a developer bearer, a casing including a bearing support and a developer container, a developer conveyor to transport, by rotation, developer in the developer container, a bearing to fit in the bearing support and support a shaft of the developer conveyor rotatably on the casing, and a heat conductor made of a material higher in thermal conductivity than the bearing support and including a heat absorbing portion to contact the bearing and absorb heat from the bearing and a heat dissipating portion to release the heat. The bearing includes an outer ring secured to the bearing support, an inner ring to rotate together with the shaft of the developer conveyor, and a ball disposed between the outer ring and the inner ring. The heat conductor is disposed to contact the outer ring of the bearing and contactless with the inner ring and the ball.

### CROSS-REFERENCE TO RELATED APPLICATIONS

This patent application is based on and claims priority pursuant to 35 U.S.C. §119(a) to Japanese Patent Application No. 2015-000427, filed on Jan. 5, 2015, in the Japan Patent Office, the entire disclosure of which is hereby incorporated by reference herein.

### BACKGROUND

1. Technical Field

Embodiments of the present invention generally relate to a developing device and an image forming apparatus, such as a copier, a printer, a facsimile machine, or a multifunction peripheral having at least two of copying, printing, facsimile transmission, plotting, and scanning capabilities, that include the developing device.

2. Description of the Related Art

There are developing devices that include a developer conveyor to transport developer by rotation and a bearing to rotatably support a rotation shaft of the developer conveyor. In such developing devices, the bearing is heated with friction.

### SUMMARY

An embodiment of the present invention provides a developing device that includes a developer bearer to bear developer, a casing including a bearing support and a developer container to contain the developer; a developer conveyor including a shaft, a bearing to fit in the bearing support of the casing, and a heat conductor including a material higher in thermal conductivity than the bearing support. The developer conveyor is configured to transport, by rotation, the developer in the developer container; and the bearing supports the shaft of the developer conveyor rotatably on the casing. The bearing includes an outer ring secured to the bearing support, an inner ring that rotates together with the shaft of the developer conveyor, and a ball disposed between the outer ring and the inner ring. The heat conductor is disposed to contact the outer ring of the bearing and contactless with the inner ring and the ball. The heat conductor includes a heat absorbing portion to contact the bearing and absorb heat from the bearing, and a heat dissipating portion to release the heat absorbed by the heat absorbing portion.

In another embodiment, an image forming apparatus includes a latent image bearer to bear a latent image, and the above-described developing device to develop the latent image on the latent image bearer with developer.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an enlarged cross-sectional view of an area around a bearing, in which an agitation screw fits, disposed on a back plate of a developing device according to an embodiment;

FIG. 2 is a schematic diagram illustrating an image forming apparatus according to an embodiment;

FIG. 3 is a perspective view, as viewed from a back side, of a process cartridge according to an embodiment;

FIG. 4 is a perspective view, as viewed from a front side, of the process cartridge illustrated in FIG. 3;

FIG. 5 is a schematic cross-sectional view illustrating the process cartridge;

FIG. 6 is an enlarged cross-sectional view of the developing device illustrated in FIG. 1;

FIG. 7 is a perspective view of the developing device illustrated in FIG. 6;

FIG. 8 is a perspective view of a front plate of the developing device illustrated in FIG. 7, as viewed from the front side;

FIG. 9 is a perspective view of the back plate of the developing device illustrated in FIG. 7, as viewed from a center side of the developing device;

FIG. 10 is a perspective view of a center casing of the developing device illustrated in FIG. 7, as viewed from the back side;

FIG. 11 is a schematic top view of a printer body of the image forming apparatus illustrated in FIG. 2;

FIG. 12 is a perspective view of a back end portion of the developing device illustrated in FIG. 7, from which a gear cover is removed;

FIG. 13 is a perspective view of the back end portion of the developing device illustrated in FIG. 12, from which a gear is removed;

FIG. 14A illustrates a heat dissipater having a projection according to an embodiment;

FIG. 14B illustrates a heat dissipater having a projection according to a variation; and

FIG. 14C illustrates a metal part having a projection according to another variation.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

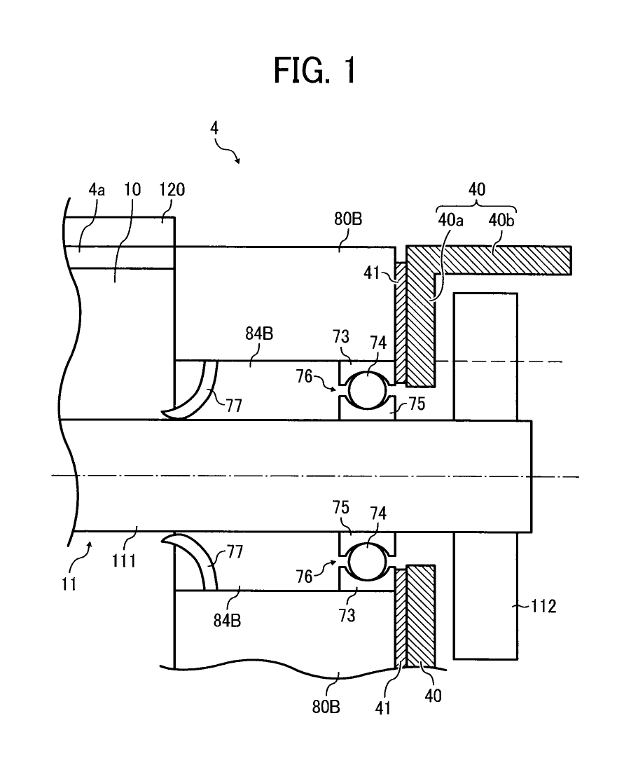

Referring now to the drawings, wherein like reference numerals designate identical or corresponding parts throughout the several views thereof, and particularly to FIG. 1, a multicolor image forming apparatus according to an embodiment of the present invention is described.

A tandem-type multicolor laser printer including multiple photoconductors arranged side by side is described below as an image forming apparatus according to an embodiment of the present invention.

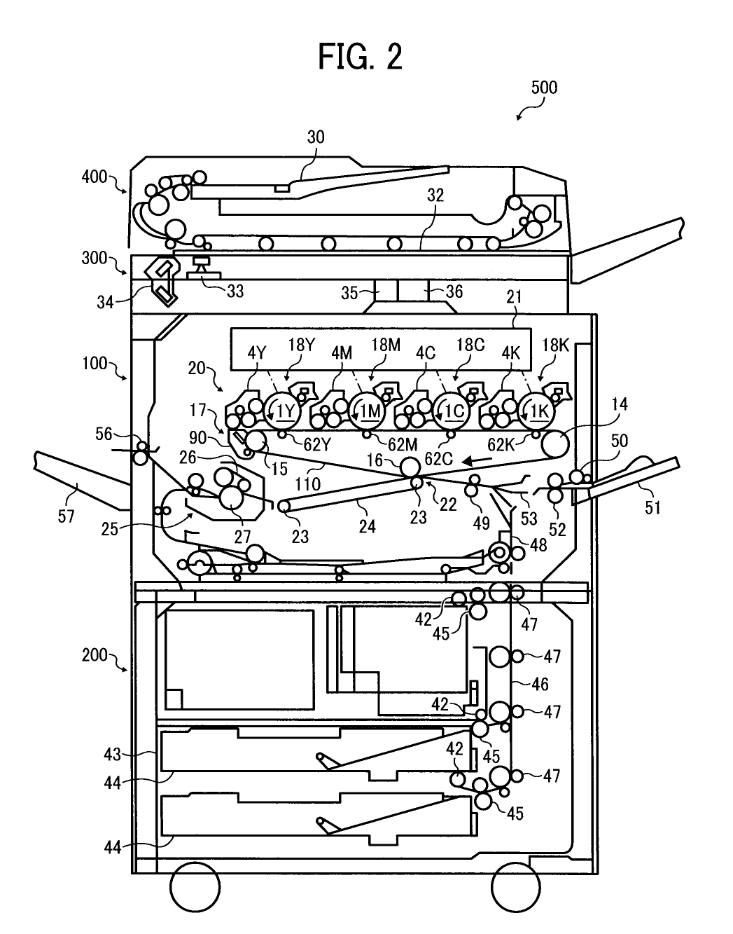

FIG. 2 is a schematic diagram illustrating an image forming apparatus 500 according to the present embodiment.

The image forming apparatus 500 can be, for example, a copier, and includes a printer body 100, a sheet feeder 200 on which the printer body 100 is mounted, and a scanner 300 fixed above the printer body 100. The image forming apparatus 500 further includes an automatic document feeder (ADF) 400 attached on the scanner 300.

The printer body 100 includes a tandem unit 20 including four process cartridges 18Y, 18M, 18C, and 18K (also collectively “process cartridges 18”) for forming yellow (Y), magenta (M), cyan (M), and black (K) images. It is to be noted that suffixes Y, M, C, and K attached to each reference numeral indicate that components indicated thereby are used for forming yellow, magenta, cyan, and black images, respectively.

The image forming apparatus 500 further includes an optical writing unit 21, an intermediate transfer unit 17, a secondary transfer device 22, a registration roller pair 49, and a belt-type fixing device 25.

The optical writing unit 21 includes a light source, a polygon mirror, an f-θ lens, and reflection mirrors, and is configured to direct laser beams onto surfaces of four photoconductors 1 according to image data.

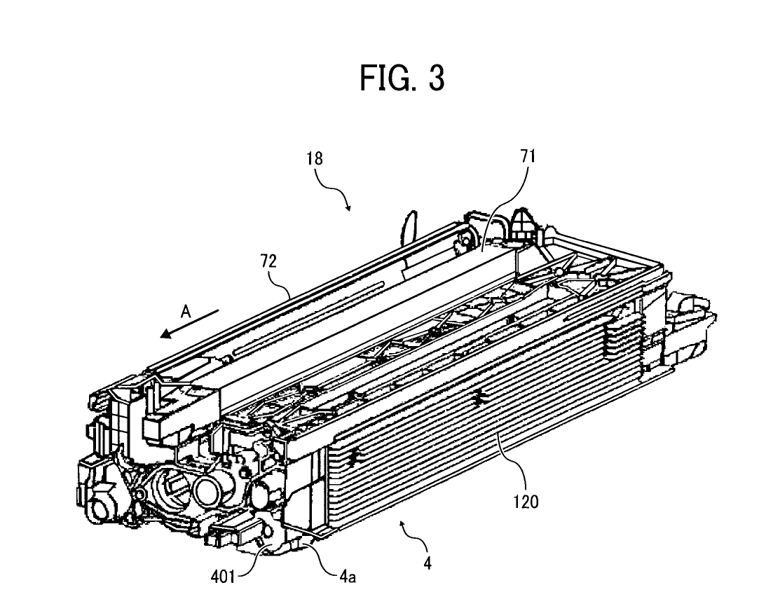

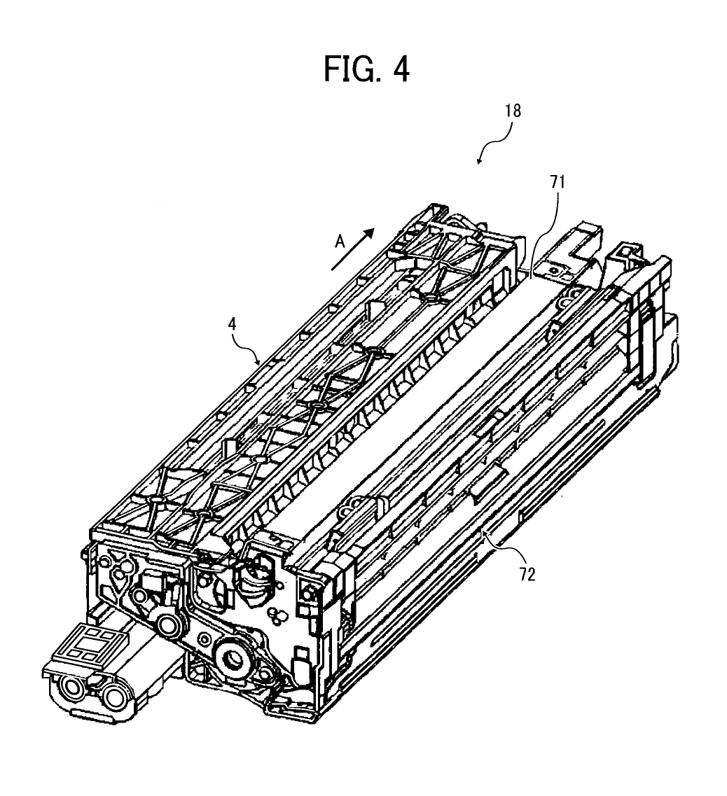

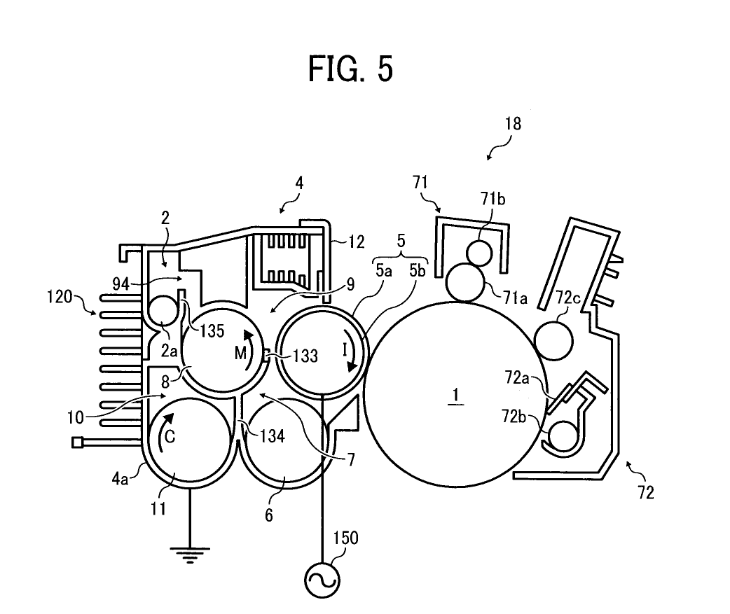

FIG. 3 is a perspective view of one of the four process cartridges 18 as viewed from the back side of the paper on which FIG. 2 is drawn. FIG. 4 is a perspective view of the process cartridge 18 as viewed from the front side of the paper on which FIG. 2 is drawn. FIG. 5 is a schematic view of the process cartridge 18. Hereinafter the term “axial direction” means the direction perpendicular to the surface of the paper on which FIG. 2 or 5 is drawn. The terms “front side in the axial direction” and “back side in the axial direction” respectively mean those of the paper on which FIG. 2 or 5 is drawn.

Since the process cartridges 18Y, 18M, 18C, and 18K are similar in configuration, the subscripts Y, C, M, and K for color discrimination are omitted in the description below regarding the configuration and operation of the process cartridges 18 when color discrimination is not necessary.

Each of the process cartridges 18 is inserted into the body of the image forming apparatus 500, from the front side to the back side in the axial direction as indicated by arrow A in FIGS. 3 and 4, and mounted therein.

As illustrated in FIG. 5, the process cartridge 18 includes, in addition to the drum-shaped photoconductors 1, a drum cleaning device 72 (72Y, 72M, 72C, or 72K), a charging device 71 (71Y, 71M, 71C, or 71K), and a developing device 4 (4Y, 4M, 4C, or 4K) disposed around the photoconductor 1. The developing device 4 is an integral part of the process cartridge 18 and removably installed in the body of the image forming apparatus 500 together with other components of the process cartridge 18. The developing device 4 includes a cooling section 120 disposed on a side face of a center casing 4a made of metal, for example. Additionally, as illustrated in FIG. 3, a gear cover 401 covers a back end of the developing device 4 in the axial direction to inhibit adhesion of foreign substances such as dust to drive transmission gears.

The drum cleaning device 72 mainly includes a cleaning blade 72a, which is elastic and long in the axial direction, and a discharge screw 72b. In the drum cleaning device 72, a long side (contact side or an edge portion) of the cleaning blade 72a is pressed against the surface of the photoconductor 1 to remove substances, such as residual toner, from the surface of the photoconductor 1. The discharge screw 72b discharges the removed toner outside the drum cleaning device 72. The drum cleaning device 72 further includes a charge remover 72c to which direct voltage is applied.

The charging device 71 includes a charging roller 71a disposed to abut the photoconductor 1 and a charging roller cleaner 71b that rotates while abutting the charging roller 71a.

The developing device 4 includes the developing roller 5 serving as a developer bearer to supply toner to an electrostatic latent image on the photoconductor 1 while rotating in the direction indicated by arrow I in FIG. 5. The center casing 4a of the developing device 4 defines a developer container (including a collecting compartment 7, a supply compartment 9, and an agitation compartment 10) to contain developer. Although two-component developer including toner and carrier is used in the present embodiment, one-component development may be employed as long as the developing device includes a developer conveyor that transports the developer by rotation.

The developing roller 5 includes a cylindrical developing sleeve 5a made of a nonmagnetic material and a magnet roller 5b disposed inside the developing sleeve 5a. The developing sleeve 5a rotates around the magnet roller 5b, and the magnet roller 5b includes multiple stationary magnets. As the developing sleeve 5a rotates around the magnet roller 5b that generates multiple magnetic poles, developer moves in the circumferential direction (in the direction of arc) of the developing roller 5.

With a developing bias applied from a power source 150 to the developing sleeve 5a, a developing electrical field is generated between the developing sleeve 5a and the photoconductor 1 in the developing range. With the development field, the toner in developer carried on the surface of the developing sleeve 5a is supplied to the latent image on the surface of the photoconductor 1, developing it.

The developing device 4 includes a developer doctor 12, serving as a developer regulator, to adjust to a desired or given thickness the developer supplied to the developing roller 5. The developer doctor 12 is disposed downstream from a portion where the developing roller 5 faces a supply screw 8 in the direction in which the developing roller 5 rotates.

The center casing 4a includes a first partition 133 and a second partition 134. The first partition 133 and the second partition 134 divide the developer container in the developing device 4 into the collecting compartment 7, the supply compartment 9, and the agitation compartment 10 (i.e., a stirring compartment).

The supply screw 8 is disposed in the supply compartment 9 to transport the developer from the back side to the front side in the axial direction while supplying the developer to the developing roller 5. In FIG. 5, the supply screw 8 rotates in the direction indicated by arrow M.

The collecting compartment 7 is disposed downstream in the direction of rotation of the developing roller 5 from the developing range where the developing roller 5 faces the photoconductor 1. The developer that has passed through the developing range falls to the collecting compartment 7 and collected therein. A collecting screw 6 is disposed in the collecting compartment 7. The collecting screw 6 transports the developer in the direction identical to the direction in which the supply screw 8 transports the developer (hereinafter “developer conveyance direction”). The supply compartment 9 is on a side of the developing roller 5, and the collecting compartment 7 is located below the developing roller 5. The agitation compartment 10 is positioned below the supply compartment 9 and on a side of the collecting compartment 7. An agitation screw 11 is disposed in the agitation compartment 10 to transport the developer from the front side to the back side in the axial direction, while agitating the developer. The agitation screw 11 rotates in the direction indicated by arrow C in FIG. 5 and transports the developer in the direction opposite the developer conveyance direction of the supply screw 8.

Each of the collecting screw 6, the supply screw 8, and the agitation screw 11 serves as a developer conveyor and includes a shaft and a blade provided on the shaft to transport the developer axially by rotating.

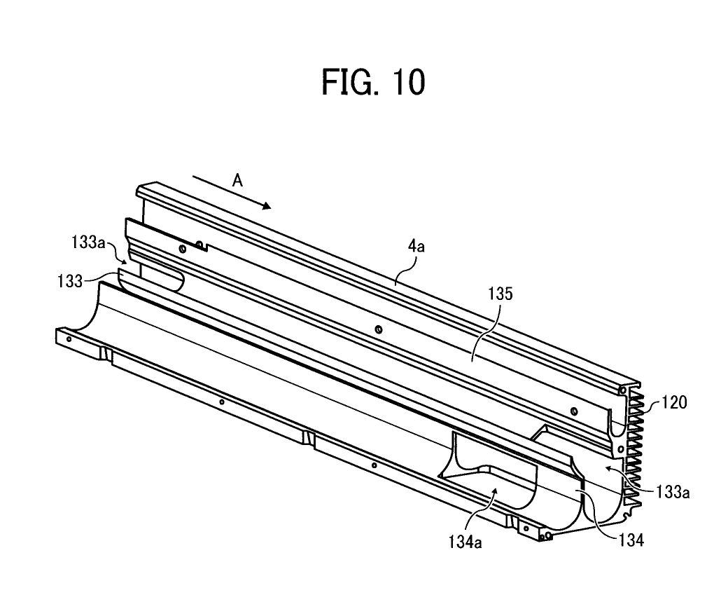

The first partition 133 separates, at least partly, the supply compartment 9 from the agitation compartment 10. The first partition 133 includes openings 133a (illustrated in FIG. 10) positioned on the front side and the back side in the axial direction, and the supply compartment 9 and the agitation compartment 10 communicate with each other through the openings 133a.

It is to be noted that the supply compartment 9 and the collecting compartment 7 are separated by the first partition 133 as well, and the first partition 133 does not include an opening to allow the supply compartment 9 and the collecting compartment 7 to communicate with each other.

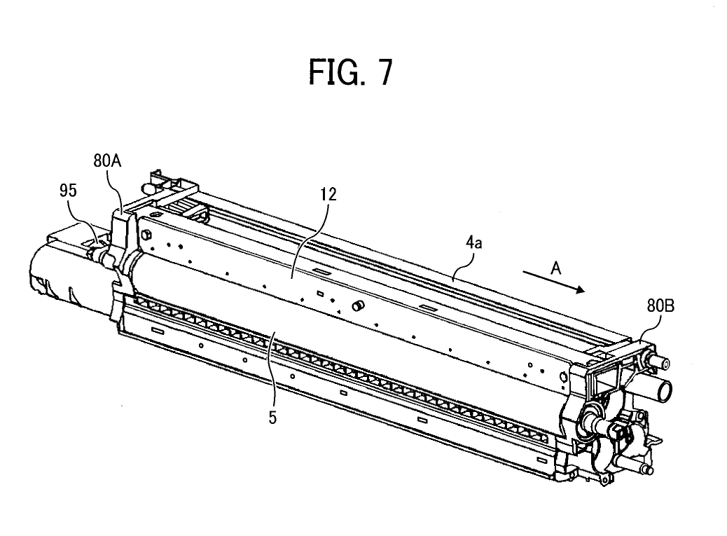

The second partition 134 separates the agitation compartment 10 from the collecting compartment 7. The agitation compartment 10 and the collecting compartment 7 communicate with each other in an area close to a toner supply inlet 95 illustrated in FIG. 7. The toner supply inlet 95 is positioned on the downstream side in the developer conveyance direction by the collecting screw 6 and the upstream side in the developer conveyance direction by the agitation screw 11.

The supply compartment 9 includes a developer outlet 94 to discharge a part of developer contained therein when the level of the developer in the supply compartment 9 exceeds a predetermined level. The developer discharged from the developer outlet 94 is transported through a discharge passage 2 to the outside of the developing device 4, and a discharge screw 2a is disposed in the discharge passage 2. The discharge passage 2 is positioned on the side of the supply compartment 9 via a partition 135. The developer outlet 94 is an opening in the partition 135 to allow the supply compartment 9 and the discharge passage 2 to communicate with each other.

The charging device 71 uniformly charges the surface of the photoconductor 1. Then, the optical writing unit 21 directs the laser beam, which is modulated and deflected, to the charged surface of the photoconductor 1. The laser beam (exposure light) attenuates the electrical potential of the portion of the photoconductor 1 thus exposed, forming an electrostatic latent image thereon. Then, the developing device 4 develops the electrostatic latent image on the photoconductor 1 into a toner image.

The toner image is primarily transferred from the photoconductor 1 onto an intermediate transfer belt 110. Subsequently, the cleaning blade 72a of the drum cleaning device 72 removes toner remaining on the surface of the photoconductor 1. Further, the charge remover 72c removes electrical potential remaining on the photoconductor 1, after which the charging device 71 uniformly charges the surface of the photoconductor 1. Thus, the photoconductor 1 is initialized.

Next, the intermediate transfer unit 17 is described below with reference to FIG. 2.

The intermediate transfer unit 17 includes the intermediate transfer belt 110, a belt cleaning device 90, a tension roller 14, a driving roller 15, a secondary-transfer backup roller 16, and four primary-transfer bias rollers 62 (62Y, 62M, 62C, and 62K).

The intermediate transfer belt 110 is entrained taut around multiple rollers including the tension roller 14 and rotates clockwise in FIG. 2 as the driving roller 15 rotates, driven by a belt driving motor.

Each of the four primary-transfer bias rollers 62 is disposed in contact with an inner circumferential surface of the intermediate transfer belt 110 and receives a primary transfer bias from a power supply. The four primary-transfer bias rollers 62 press the intermediate transfer belt 110 against the respective photoconductors 1 from the inner circumferential side. That is, the intermediate transfer belt 110 is nipped therebetween, and the nips are called primary transfer nips. The primary transfer bias causes a primary-transfer electrical field between the photoconductor 1 and the primary-transfer bias roller 62 in the primary transfer nip.

A yellow toner image is transferred from the photoconductor 1Y onto the intermediate transfer belt 110 with the effects of the primary-transfer electrical field and the nip pressure. Subsequently, magenta, cyan, and black toner images are transferred from the photoconductors 1M, 1C, and 1K and superimposed one on another on the yellow toner image. Thus, a superimposed four-color toner image is formed on the intermediate transfer belt 110.

The four-color toner image on the intermediate transfer belt 110 is transferred onto a transfer sheet (i.e., a recording medium) in a secondary transfer nip (secondary transfer process). The belt cleaning device 90 is disposed downstream from the secondary transfer nip in the transfer sheet conveyance direction, nipping the intermediate transfer belt 110 with the driving roller 15 on the left in FIG. 2. The belt cleaning device 90 removes toner remaining on the intermediate transfer belt 110 after the secondary transfer process.

The secondary transfer device 22 is described in further detail below.

The secondary transfer device 22 is disposed below the intermediate transfer unit 17 in FIG. 2 and includes a conveyor belt 24 looped around two tension rollers 23. The conveyor belt 24 rotates counterclockwise in FIG. 2 as at least one of the two tension rollers 23 rotates.

The intermediate transfer belt 110 and the conveyor belt 24 are nipped between the secondary-transfer backup roller 16 and the tension roller 23 on the right in FIG. 2. Thus, the intermediate transfer belt 110 is in contact with the conveyor belt 24 of the secondary transfer device 22, and the contact portion is called the secondary transfer nip.

A secondary transfer bias opposite in polarity to the toner is applied to the tension roller 23 on the right from a power supply. The secondary transfer bias causes a secondary-transfer electrical field in the secondary transfer nip to electrically transfer the four-color toner image on the intermediate transfer belt 110 from the side of the secondary-transfer backup roller 16 toward the tension roller 23.

Timed to coincide with the four-color toner image, the registration roller pair 49 forwards the transfer sheet to the secondary transfer nip, and the four-color toner image is secondarily transferred onto the transfer sheet with nip pressure and effects of the transfer electrical field.

It is to be noted that, instead of applying the secondary transfer bias to one of the tension rollers 23, a contactless charger to charge the transfer sheet may be used.

The sheet feeder 200 disposed below the printer body 100 includes a paper bank 43 in which multiple sheet feeding trays 44 are arranged vertically. Each sheet feeding tray 44 can contain a bundle of transfer sheets. Each sheet feeding tray 44 is provided with a sheet feeding roller 42 pressed against the transfer sheet on the top in the sheet feeding tray 44. As the sheet feeding roller 42 rotates, the transfer sheet is conveyed to a sheet feeding path 46.

Multiple pairs of conveyance rollers 47 are disposed along the sheet feeding path 46, and the registration roller pair 49 is positioned close to an end of the sheet feeding path 46. The transfer sheet is conveyed toward the registration roller pair 49 and then clamped in the nip between the registration roller pair 49.

Meanwhile, the four-color toner image on the intermediate transfer belt 110 enters the secondary transfer nip as the intermediate transfer belt 110 rotates. The registration roller pair 49 forwards the transfer sheet clamped therebetween so that the transfer sheet contacts the four-color image in the secondary transfer nip. Thus, the four-color toner image is transferred onto the transfer sheet in the secondary transfer nip, forming a full-color image on the transfer sheet that is white. As the conveyor belt 24 rotates, the transfer sheet carrying the full-color toner image is discharged from the secondary transfer nip and conveyed to the fixing device 25.

The fixing device 25 includes a belt unit to rotate a fixing belt 26 looped around two rollers as well as a pressure roller 27 pressed against one of the two rollers of the belt unit. In the fixing device 25, the fixing belt 26 and the pressure roller 27 press against each other, forming a fixing nip therebetween, and the transfer sheet conveyed by the conveyor belt 24 is clamped in the fixing nip.

A heat source to heat the fixing belt 26 is disposed inside one of the two rollers of the belt unit. The heated fixing belt 26 heats the transfer sheet nipped on in the fixing nip, and the full-color toner image is fixed on the transfer sheet with the heat and nip pressure (fixing process).

After the fixing process, discharge rollers 56 discharge the transfer sheet to a stack tray 57 protruding from a side plate of the printer body 100 on the left in FIG. 2. Alternatively, the transfer sheet is conveyed again to the secondary transfer nip for forming an image on the back side thereof.

To make copies of a bundle of documents, users place the bundle of documents, for example, on a document table 30 of the ADF 400.

If the bundle of documents is bound like a book on one side (side-stitched documents), the bundle is placed on an exposure glass 32. Specifically, the user lifts the ADF 400 to expose the exposure glass 32 of the scanner 300, sets the bundle on the exposure glass 32, and then lowers the ADF 400 to hold the bundle with the ADF 400.

Then, the user presses a copy start switch, and the scanner 300 starts reading image data of the documents. When the documents are set on the ADF 400, the ADF 400 automatically conveys the documents to the exposure glass 32 before reading the image data.

In reading the image data, first and second carriages 33 and 34 start moving, and the first carriage 33 directs an optical beam from the light source onto the document.

Subsequently, the optical beam reflected from a surface of the document is reflected by the mirror of the second carriage 34, passes through an image forming lens 35, and then enters the reading sensor 36. Thus, the reading sensor 36 captures the image data of the document.

In parallel to reading of image data, components of the process cartridges 18, the intermediate transfer unit 17, the secondary transfer device 22, and the fixing device 25 start operating.

According to the image data captured by the reading sensor 36, the optical writing unit 21 is driven, and yellow, magenta, cyan, and black toner images are formed on the respective photoconductors 1. The developing devices 4 develop the electrostatic latent images onto the yellow, magenta, cyan, and black toner images. These toner images are superimposed on the intermediate transfer belt 110 and become the four-color toner image.

Almost simultaneously with the start of image data reading, the sheet feeder 200 starts feeding sheets. Specifically, one of the sheet feeding rollers 42 is selectively rotated, and the transfer sheets are fed from the corresponding sheet feeding tray 44. The transfer sheets are fed one by one to the sheet feeding path 46, separated by a separation roller 45, after which the pairs of conveyance rollers 47 convey the transfer sheet to the secondary transfer nip.

Instead of the sheet feeding tray 44, the transfer sheets may be fed from a side tray 51 (i.e., a bypass tray) projecting from the side of the printer body 100. In this case, a sheet feeding roller 50 is rotated to feed the transfer sheets from the side tray 51, and a separation roller 52 forwards the transfer sheets one by one to a feed path 53 inside the printer body 100.

When multicolor toner images are formed using two or more toners, the intermediate transfer belt 110 is disposed with its upper portion substantially horizontal and in contact with the photoconductors 1Y, 1M, 1C, and 1K.

By contrast, when monochrome images (black toner images) are formed, the upper portion of the intermediate transfer belt 110 is tilted with the left side of the upper portion in FIG. 2 lowered. Then, the upper portion of the intermediate transfer belt 110 is disengaged from the photoconductors 1Y, 1M, and 1C.

Then, only the photoconductor 1K out of the four photoconductors 1 is rotated counterclockwise in FIG. 1 to form a black toner image. At that time, not only the photoconductors 1Y, 1M, and 1C but also the developing devices 4Y, 4M, and 4C are stopped to prevent wear of the photoconductors 1Y, 1M, and 1C and waste of developer.

The developing device 4 is described in further detail below.

FIG. 4 is an enlarged cross-sectional view of the developing device 4 according to the present embodiment, and FIG. 5 is a perspective view of the developing device 4.

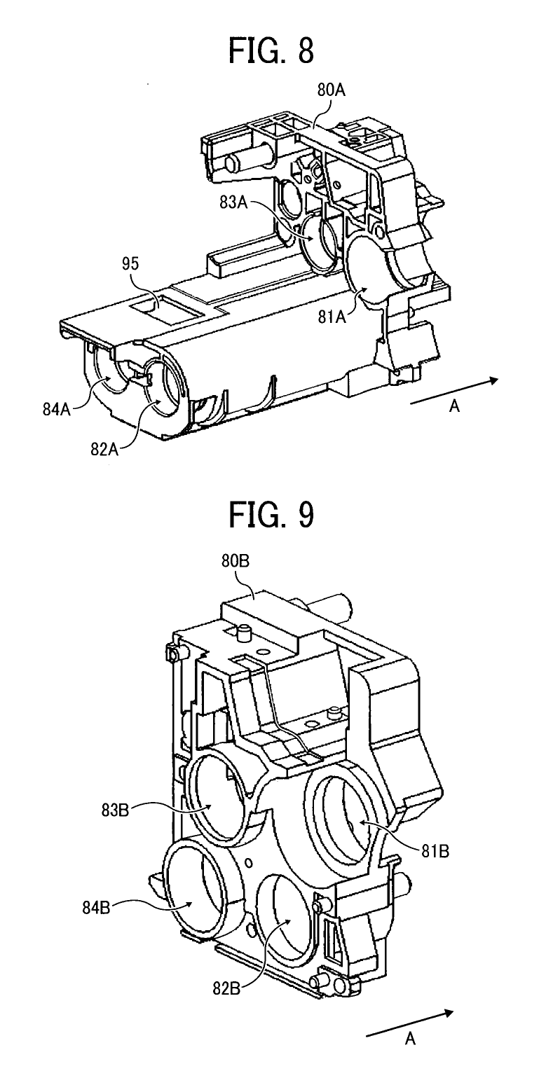

The developing device 4 includes a front plate 80A and a back plate 80B respectively attached to the axial ends of the center casing 4a, which is made of metal and defines the supply compartment 9, the collecting compartment 7, the agitation compartment 10, and the cooling section 120. FIG. 8 is a perspective view of the front plate 80A as viewed from the front side in the axial direction, and FIG. 9 is a perspective view of the back plate 80B as viewed from a center side (the front side in the axial direction). FIG. 10 is a perspective view of the center casing 4a as viewed from the back side in the axial direction.

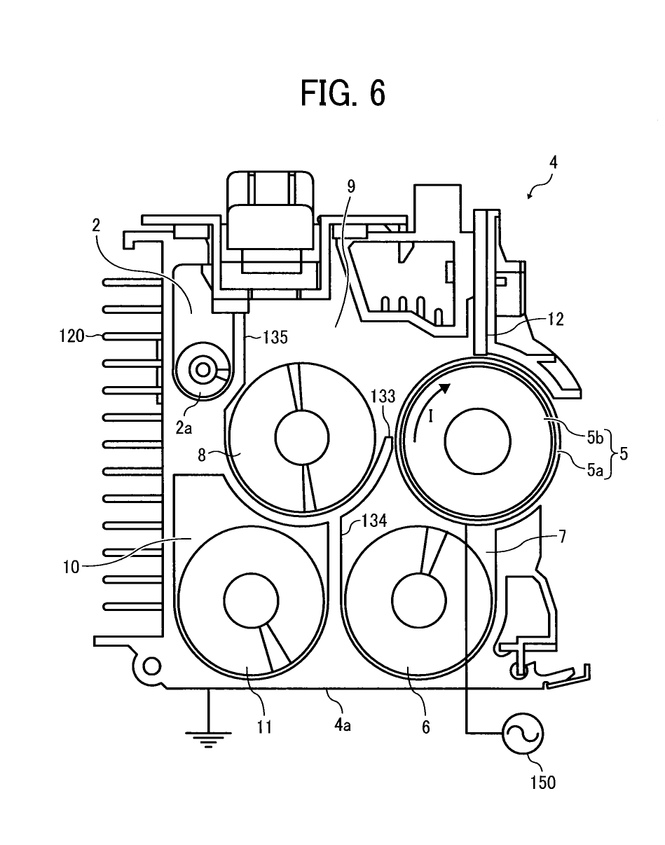

As illustrated in FIG. 10, the center casing 4a made of metal, such as aluminum, includes the first partition 133, the second partition 134, and the cooling section 120 formed by monolithic molding. As illustrated in FIG. 3, the cooling section 120 includes multiple radiating fins each extending in the longitudinal direction (axial direction). The center casing 4a is electrically grounded, as illustrated in FIG. 6. Although the developer container and the cooling section 120 are integral parts of the center casing 4a being a monolithic molded component, separate components may be jointed instead.

As the developer conveyors (the collecting screw 6, the supply screw 8, and the agitation screw 11) transport the developer in the developing device 4, the developer is supplied to the developing roller 5 while circulating inside the developer container.

The center casing 4a made of metal is advantageous in efficiently conducting, to the cooling section 120, the heat generated by friction between the developer conveyors and the developer, which arises when the developer conveyors are driven, and friction among developer particles. The heat can be effectively released from the developing device 4 with the cooling section 120, thereby suppressing temperature rise inside the developing device 4. As a result, decreases in the charge amount of toner caused by the temperature rise in the developing device 4 are suppressed, and toner is inhibited form being fused and from adhering to the developer doctor 12 or the developing roller 5. Thus, degradation of image quality is inhibited.

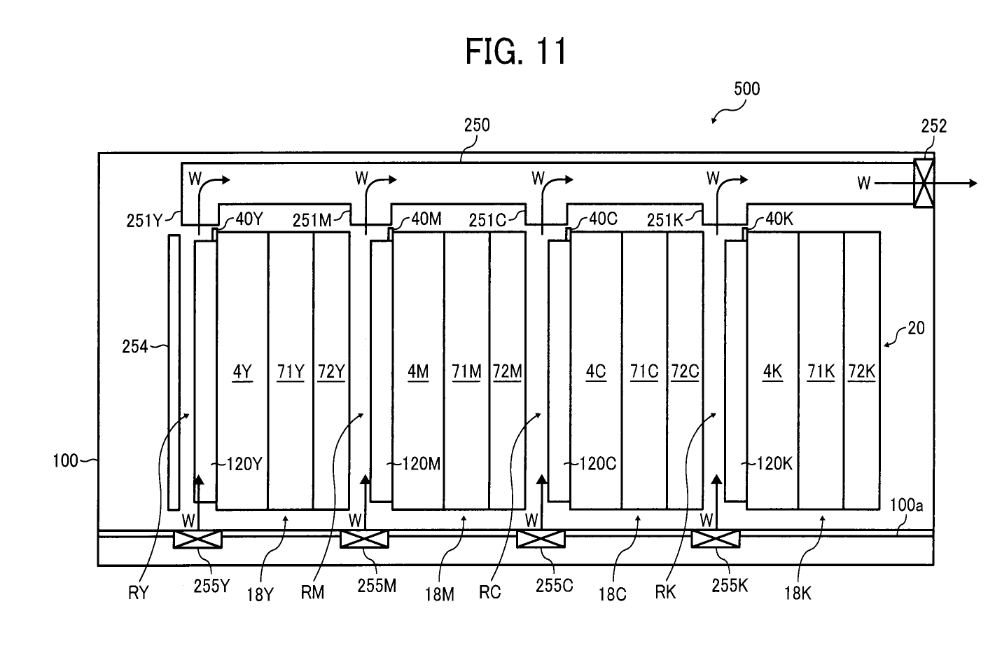

FIG. 11 is a schematic top view of the printer body 100 of the image forming apparatus 500.

As illustrated in FIG. 11, the printer body 100 includes a front plate 100a serving as an inner cover and disposed on the front side in the axial direction, and fans 255Y, 255M, 255C, and 255K (collectively “fans 255”) are disposed on the front plate 100a. The fans 255 send air to the cooling sections 120 of the developing devices 4, respectively. In FIG. 11, arrows W indicate airflow directions inside the printer body 100, and reference numeral 40 (40Y, 40M, 40C, and 40K) represent a heat conduction plate.

The fan 255K faces a cooling channel RK for black located between the developing device 4K and the drum cleaning device 72C for cyan. The fan 255C faces a cooling channel RC for cyan located between the developing device 4C and the drum cleaning device 72M magenta. The fan 255M faces a cooling channel RM for magenta located between the developing device 4M and the drum cleaning device 72Y yellow. The fan 255Y faces a cooling channel RY for yellow located between a left wall 254 of the printer body 100 and the developing device 4Y.

No units such as the process cartridges 18 for other colors are disposed facing the side of the developing device 4Y on which the cooling section 120Y is disposed. Accordingly, in the present embodiment, the left wall 254 is disposed to face the cooling section 120Y for yellow to define the cooling channel RY between the left wall 254 and the cooling section 120.

An exhaust duct 250 is disposed on the back side (back side in the axial direction) of the printer body 100. The exhaust duct 250 includes duct entrances 251Y, 251M, 251C, and 251K (collectively “duct entrances 251”) to communicate with the cooling channel RY, RM, RC, and RK (collectively “cooling-air channels R”), respectively. The exhaust duct 250 connects to an exhaust fan 252 disposed facing a vent of the printer body 100.

As the developing device 4 is mounted in the image forming apparatus 500 and the image forming apparatus 500 is driven, the four fans 255 and the exhaust fan 252 are driven, and air flows through the cooling-air channels R. The air cools the cooling sections 120, after which the air is exhausted from the apparatus by the exhaust fan 252.

The center casing 4a is made of a conductive metal and grounded electrically, which attains the following effects.

If the center casing 4a is made of an insulative material such as plastic, it is possible that electrical charges of charged developer charge up the center casing 4a, resulting in image failure. For example, the charged center casing 4a attracts the toner circulating therein and causes the toner to adhere to a wall face thereof. When the toner falls from the center casing 4a and is used in image developing, spots appear in images, or toner is partly absent in images like white dots. Additionally, in a configuration in which the intermediate transfer belt 110 is situated below the developing device 4, it is possible electrical force acts between the charged center casing 4a and the toner image on the intermediate transfer belt 110. Such electrical force can disturb the toner image, resulting in scattering of toner or fading of the image.

In the developing device 4 according to the present embodiment, electrically grounding the conductive center casing 4a can prevent the above-described failures induced by the charging up of the center casing 4a.

Additionally, the center casing 4a is an extruded metal product. Use of an extruded product is advantageous in producing the center casing 4a that is relatively long and includes a tubular portion with its cross-sectional shape uniform in the longitudinal direction.

As illustrated in FIG. 10, the second partition 134 of the center casing 4a includes an opening 134a positioned on the back side in the axial direction. The opening 134a allows the agitation compartment 10 and the collecting compartment 7 to communicate with each other. The opening 134a in the second partition 134 penetrates a bottom side of the center casing 4a. To the opening 134a, a toner concentration sensor is mounted to detect the concentration or density of toner close to the downstream end in the direction in which the developer is transported in the agitation compartment 10. When the developing device 4 is used, the opening 134a is closed with the toner concentration sensor and fitting parts thereof.

The front plate 80A illustrated in FIG. 8 and the back plate 80B illustrated in FIG. 9 have capabilities to rotatably support the developing roller 5, the collecting screw 6, the supply screw 8, and the agitation screw 11 via bearings. The front plate 80A and the back plate 80B are molded with resin and include hollow portions in which the bearings are fitted.

An inner face enclosing the hollow defines bearing insertion portions (i.e., bearing engagement portions) 81, 82, 83, and 84.

Into the bearing insertion portions 81 (81A and 81B), the bearings of the developing roller 5 are fitted. Into the bearing insertion portions 82 (82A and 82B), the bearings of the collecting screw 6 are fitted. Into the bearing insertion portions 83 (83A and 83B), the bearings of the supply screw 8 are fitted. Into the bearing insertion portions 84 (84A and 84B), agitation bearings 76 of the agitation screw 11 are fitted. The bearings are fitted in the respective bearing insertion portions 81, 82, 83, and 84 by press fit and secured to the front plate 80A and the back plate 80B. Then, the positions of the developing roller 5, the collecting screw 6, the supply screw 8, and the agitation screw 11 are determined relatively to the front plate 80A and the back plate 80B. Simultaneously, the relative positions of the developing roller 5, the collecting screw 6, the supply screw 8, and the agitation screw 11 are determined.

The front plate 80A and the back plate 80B include the multiple bearing insertion portions and thus are complicated in shape. It is difficult to produce a complicated shape with a high degree of accuracy by shaving metal or casting. In the developing device 4 according to the present embodiment, the front plate 80A and the back plate 80B are made of resin material.

The front plate 80A and the back plate 80B are screwed to both ends of the center casing 4a in the axial direction.

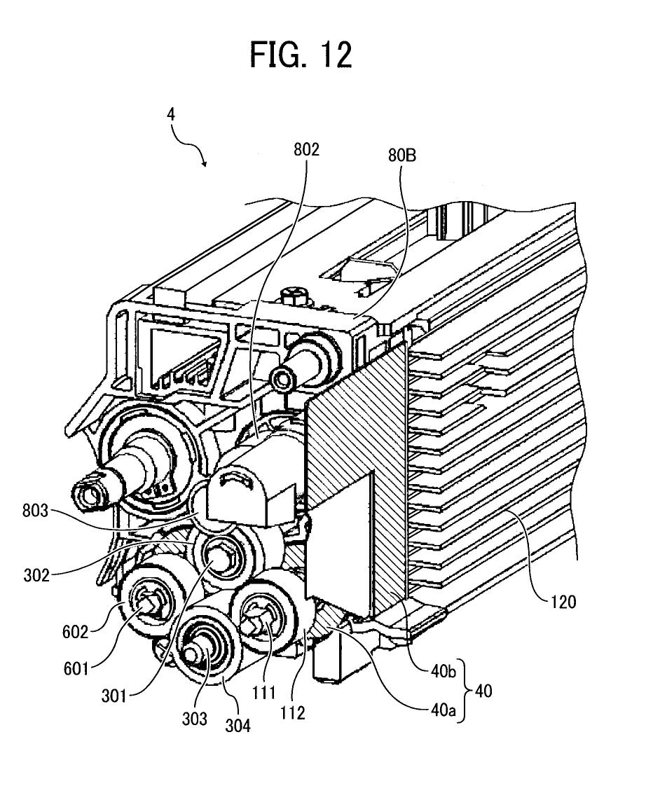

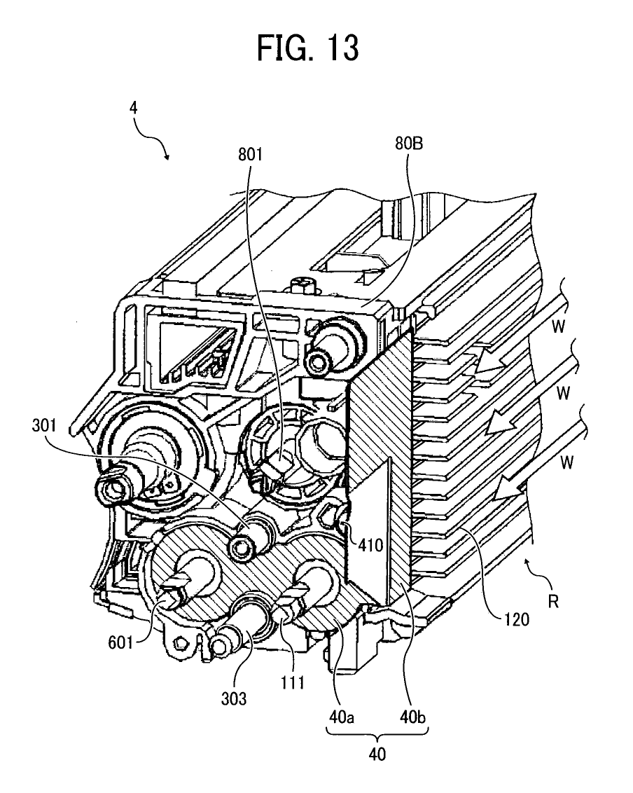

FIG. 12 is a perspective view of the back end portion of the developing device 4 in the axial direction, from which the gear cover 401 is removed. FIG. 13 is a perspective view of the back end portion of the developing device 4 in the axial direction, from which gears are removed from the state illustrated in FIG. 12.

As illustrated in FIG. 12, multiple gears are disposed inside the gear cover 401. A supply driving gear 802 is secured to a supply screw shaft 801 of the supply screw 8. A collecting driving gear 602 is secured to a collecting screw shaft 601 of the collecting screw 6. An agitation driving gear 112 is secured to an agitation screw shaft 111 of the agitation screw 11.

A first stud 301 and a second stud 303 are disposed on the back plate 80B, and a first idler gear 302 and a second idler gear 304 rotatably mesh with the first stud 301 and the second stud 303.

As illustrated in FIGS. 12 and 13, the supply driving gear 802, the collecting driving gear 602, and the agitation driving gear 112 are secured to the axial ends of the supply screw shaft 801, the collecting screw shaft 601, and the agitation screw shaft 111. Each of the supply driving gear 802, the collecting driving gear 602, and the agitation driving gear 112 includes a detent (i.e., a rotation stopper). A drive input gear 803 disposed on the supply screw shaft 801 serves as a drive transmission member to transmit driving force input from the body of the image forming apparatus 500 to the developer conveyors of the developing device 4. The drive input gear 803 transmits the driving force, via the supply driving gear 802 secured on the supply screw shaft 801, to the shafts of other developer conveyors.

Next, specific features of the developing device 4 according to the present embodiment are described below.

FIG. 1 is an enlarged cross-sectional view of an area around the bearing insertion portion 84B of the back plate 80B.

The developing device 4 includes the agitation screw 11 that transports the developer in the agitation compartment 10 serving as the developer container of the developing device 4. The developing device 4 further includes agitation bearings 76 to support the agitation screw shaft 111 and rotatably supports the agitation screw shaft 111 on the back plate 80B (the bearing insertion portions 84 in particular), which is a bearing support of the developing casing forming the agitation compartment 10.

The agitation bearing 76 is a ball bearing and includes a ball 74 (rolling element) disposed between an outer ring 73 and an inner ring 75. The outer ring 73 is secured to the back plate 80B, and the inner ring 75 rotates together with the agitation screw shaft 111. Regarding the bearing to support a rotator such as the developer conveyor rotatably on the casing of the developing device, a rolling bearing is smaller in rotation resistance than a plain bearing. Accordingly, the rolling bearing is advantageous over the plain bearing in reducing the driving load of the developing device.

The developing device 4 further includes the heat conduction plate 40 and an elastic heat conduction sheet 41 made of a material higher in thermal conductivity than the back plate 80B made of resin. The heat conduction sheet 41 is disposed to contact the outer ring 73 but not to contact the inner ring 75 and the ball 74. The heat conduction plate 40 and the heat conduction sheet 41 together serve as a heat conductor. In the present embodiment, the heat conductor is a thin part, for example.

The agitation screw shaft 111 is supported via the agitation bearing 76 by the back plate 80B. The driving force input to the supply driving gear 802, from the body of the image forming apparatus 500, is transmitted to the agitation driving gear 112, and the agitation screw 11 is driven.

As illustrated in FIG. 1, an agitation seal 77 is attached to the back plate 80B so that an inner face of the agitation seal 77 contacts the agitation screw shaft 111. The agitation seal 77 is disposed to contact the agitation screw shaft 111) at a position inner than the agitation bearing 76 in the axial direction. As the agitation screw shaft 111 rotates, the agitation seal 77 slidingly contacts the agitation screw shaft 111. The agitation seal 77 is elastic and includes an opening positioned at its center and smaller in diameter than the agitation screw shaft 111. As the agitation screw shaft 111 penetrates the opening, a periphery of the opening deforms and tightly contacts the surface of the agitation screw shaft 111. The agitation seal 77 may be an integral part of a molded piece including the back plate 80B. Alternatively, the agitation seal 77 may be a separate part attached to the back plate 80B with glue or the like.

If the developer in the agitation compartment 10 enters the bearing insertion portion 84B on the back side, there are risks that the developer solidifies between the back plate 80B and the agitation screw shaft 111 and adheres to the agitation bearing 76 and solidifies thereon, inhibiting the rotation of the agitation screw 11.

By contrast, in the present embodiment, the agitation seal 77 tightly contacting the agitation screw shaft 111 inhibits the developer from entering the bearing insertion portion 84B, thereby securing the rotation of the agitation screw 11.

Since the agitation screw shaft 111 rotates with the agitation seal 77 in tight contact therewith, the agitation seal 77 and the agitation screw shaft 111 are heated by frictional heat. Unless the heated agitation seal 77 and the agitation screw shaft 111 are cooled, temperature rises in the vicinity of the contact portion between the agitation seal 77 and the agitation screw shaft 111, and the toner in the adjacent developer melts and coheres locally. If the toner cohering into aggregation is mixed in the developer, it is possible that the toner aggregation gets stuck in the clearance (i.e., a doctor gap) between the developer doctor 12 and the developing roller 5, resulting substandard images including white lines, where toner is absent. When the toner aggregation passes the doctor gap and used in image developing, it is possible that the toner aggregation is transferred from the photoconductor 1 on to the transfer sheet and becomes spots on the image. When the toner aggregation remains on the photoconductor 1, the image has void at that position (i.e., white spots).

The developing device 4 includes the cooling section 120 on the side face of the metal center casing 4a to cool the developer in the developing device 4. The agitation seal 77 and the agitation screw shaft 111, however, are located on the back plate 80B not the center casing 4a, and the back plate 80B is made of resin lower in thermal conductivity. Accordingly, heat is not easily conducted from the agitation seal 77 and the agitation screw shaft 111 to the cooling section 120. Even if the cooling section 120 is cooled, the effect to suppress the temperature rise of the agitation seal 77 and the agitation screw shaft 111 is low.

Referring to FIGS. 1 and 12, the end face of the developing device 4 on the back side in the axial direction is covered with the multiple gears made of resin, and the gear cover 401 covers the multiple gears. This configuration does not allow direct cooling of the agitation screw shaft 111 and the agitation bearing 76. In this case, a conceivable approach is to direct air to the agitation driving gear 112 secured to the agitation screw shaft 111 to cool the agitation screw shaft 111 via the agitation driving gear 112. However, the agitation driving gear 112 is made of resin and low in thermal conductivity. It is difficult to release heat from the agitation screw shaft 111 and the agitation bearing 76 by directing air to the agitation driving gear 112.

In the developing device 4 according to the present embodiment, the heat conduction plate 40 made of metal and the heat conduction sheet 41 higher in thermal conductivity than the back plate 80B are disposed between the back plate 80B and the agitation driving gear 112. The heat conduction plate 40 contacts the heat conduction sheet 41, and the heat conduction sheet 41 contacts the outer ring 73 of the agitation bearing 76.

The heat conduction plate 40 includes a heat absorber 40a to and a heat dissipater 40b. For example, the heat conduction plate 40 is made of a sheet metal bent into the heat absorber 40a to face the outer face of the back plate 80B and the heat dissipater 40b. The heat absorber 40a extends to the rim of the end face of the back plate 80B, at which the heat absorber 40a is bent into the heat dissipater 40b. With this construction, the heat dissipater 40b serves as a wall face defining the cooling channel R as illustrated in FIGS. 11 and 13.

The frictional heat generated between the inner ring 75, which rotates with the agitation screw shaft 111, and the ball 74, as well as the frictional heat generated between the ball 74 and the outer ring 73 is conducted to the outer ring 73 and further conducted to the heat absorber 40a of the heat conduction plate 40 via the heat conduction sheet 41. The frictional heat generated between the agitation seal 77 and the agitation screw shaft 111 is conducted from the agitation screw shaft 111 to the inner ring 75 of the agitation bearing 76 and further to the ball 74 and the outer ring 73. The heat is conducted from the outer ring 73 via the heat conduction sheet 41 to the heat absorber 40a of the heat conduction plate 40. The heat is conducted from the heat absorber 40a through the heat conduction plate 40 and released from the heat dissipater 40b. Thus, the agitation screw 11 is inhibited from being heated by the frictional heat generated in the agitation bearing 76 and the frictional heat generated in the contact portion between the agitation seal 77 and the agitation screw shaft 111.

Since the heat conduction sheet 41 does not contact the inner ring 75 and the ball 74, frictional heat is not generated in the portion where the agitation bearing 76 contacts the heat conduction sheet 41. This can reduce the number of portions heated with the friction caused by the rotation of the agitation screw 11, and the amount of heat generated in the agitation bearing 76 is reduced. Thus, the temperature rise of the agitation screw 11 is suppressed, thereby inhibiting adhesion of toner caused by the heated agitation screw 11 and inhibiting image failure such as white lines, spots, and white spots.

As illustrated in FIG. 11, the fan 255 and the exhaust fan 252, which are disposed in the image forming apparatus 500, generate the airflow in the cooling-air channels R defined along the cooling section 120 of the developing device 4. The airflow promotes the heat release from the heat dissipater 40b and further inhibits the temperature rise of the contact portion between the agitation seal 77 and the agitation screw shaft 111. Thus, adhesion of toner is inhibited.

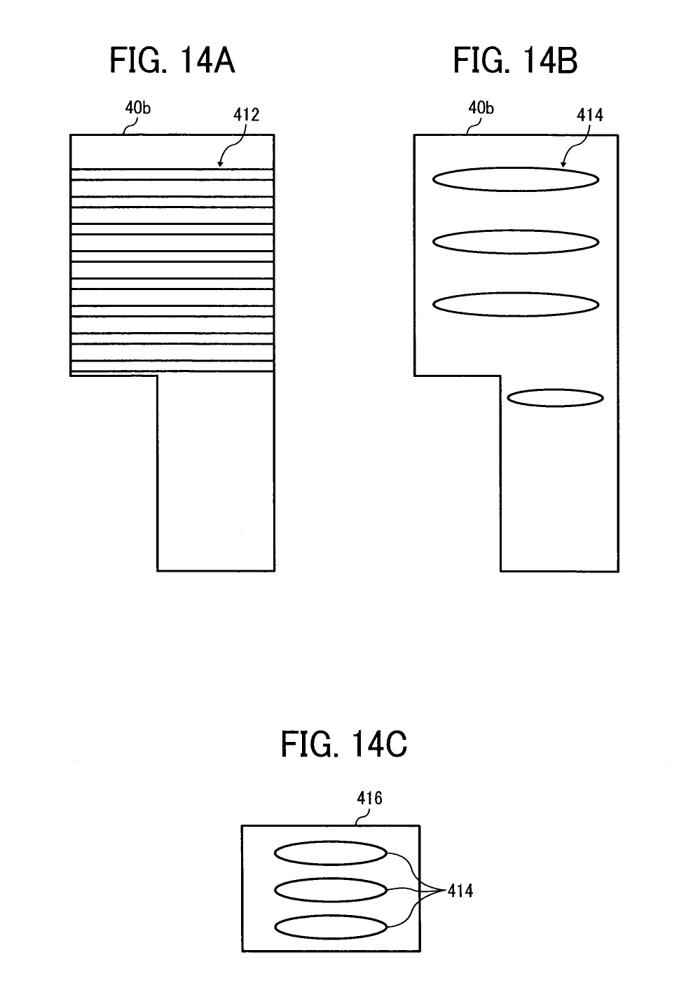

In FIG. 14A, the heat dissipater 40b includes fins 412 similar to the radiating fins of the cooling section 120. The fins 412 are projections projecting outward from the heat dissipater 40b.

Providing a projection on the heat dissipater 40b, which defines a part of the cooling channel R, is advantageous in increasing the surface area cooled by the airflow in the cooling channel R and enhancing the cooling effect.

FIG. 14B illustrates a variation of the projections of the heat dissipater 40b. In FIG. 14B, the heat dissipater 40b includes projecting portions 414 instead of the fins 412. Alternatively, the cooling effect is enhanced similarly by attaching a metal part 416 having projecting portions 414, illustrating in FIG. 14, to the channel defining face of the heat dissipater 40b.

Although the present embodiment employs air cooling and air flows in the cooling channel R, in another embodiment, liquid such as radiator liquid or coolant flows in the cooling channel R and similar effects are attained.

Although the heat conduction plate 40 contacts the outer ring 73 of the agitation bearing 76 via the heat conduction sheet 41 in the present embodiment, alternatively, the heat conduction plate 40 may directly contact the outer ring 73. Regarding outer rings usable for the agitation bearing 76, there are outer rings having end faces that are not flat. When the end face is not flat, the area of contact with the heat conduction plate 40 is smaller, and the heat conduction efficiency is reduced. By contrast, in the present embodiment in which the heat conduction plate 40 contacts the outer ring 73 via the heat conduction sheet 41, the heat conduction sheet 41 deforms conforming to the end face of the outer ring 73, and the area of contact with the outer ring 73 increases. Thus, the heat conduction efficiency is increased.

Additionally, the heat conduction plate 40 is attached to the outer face of the back plate 80B with a screw 410 (illustrated in FIG. 13) serving as a pressing member in the present embodiment. The pressing member to press the heat conduction plate 40 is not limited to the screw 410 but include a clip, a pin, a spring clamp, and the like.

Thus, the heat conduction plate 40 is pressed to tightly contact the outer ring 73 via the heat conduction sheet 41. With this construction, clearance is not allowed between the outer ring 73 and the heat conduction sheet 41 as well as between the heat conduction sheet 41 and the heat conduction plate 40. Thus, the heat conduction efficiency from the agitation bearing 76 to the heat conduction plate 40 is enhanced.

Regarding the ball bearing used in the agitation bearing 76 according to the present embodiment, the outer ring 73, the ball 74, and the inner ring 75 are made of iron, and the agitation screw shaft 111 of the agitation screw 11 is made of iron as well. Use of the iron ball bearing for the agitation bearing 76 and the iron shaft for the agitation screw shaft 111 is advantageous in increasing the efficiently of heat conduction from the agitation screw shaft 111, via the agitation bearing 76, to the heat conduction plate 40. Since the agitation screw shaft 111 that contacts the agitation seal 77 is made of metal higher in thermal conductivity, the frictional heat caused between the agitation seal 77 and the agitation screw shaft 111 is efficiently conducted to the heat conduction plate 40 via the agitation screw shaft 111 and the agitation bearing 76.

In the developing device 4 according to the present embodiment, the agitation screw 11 is higher in rotation speed than the supply screw 8, and the agitation screw 11 and the collecting screw 6 are identical in rotation speed. Accordingly, as illustrated in FIGS. 12 and 13, the heat absorber 40a of the heat conduction plate 40 extends to a position facing the bearing of the collecting screw 6 on the back side in the axial direction so that the heat conduction plate 40 absorbs heat also from the bearing of the collecting screw 6. Although the heat conduction plate 40 does not absorb heat from the bearing of the supply screw 8 in the present embodiment, in another embodiment, a similar structure is used to cool the bearing of the supply screw 8.

As illustrated in FIG. 8, the bearing insertion portion 82A and the bearing insertion portion 84A, to which the front side bearings of the collecting screw 6 and the agitation screw 11 are respectively fitted, are disposed at the end of the developing device 4 on the front side in the axial direction. The end faces of the bearings fitted to the bearing insertion portions 82A and 84A, respectively, are exposed, and these bearings can be cooled directly. Accordingly, heat is less likely to accumulate on these bearings. Therefore, in the present embodiment, the heat conduction plate 40 is disposed only on the back side in the axial direction. However, the developing device 4 may further include a heat conduction plate to contact the bearings on the bearings of the front side in the axial direction to promote the release of heat.

The various aspects of the present specification can attain specific effects as follows.

Aspect A

A developing device that includes a developer bearer (e.g., the developing roller 5); a developer conveyor (e.g., the agitation screw 11) including a rotation shaft (e.g., the agitation screw shaft 111) and configured to transport, by rotation, developer in a developer container (e.g., the agitation compartment 10); a bearing (e.g., the agitation bearing 76) to fit in a bearing support (e.g., the bearing insertion portion 84) of a casing that defines the developer container (e.g., the center casing 4a, the front plate 80A, and the back plate 80B) and configured to support the rotation shaft (e.g., the agitation screw shaft 111) rotatably on the casing; a heat conductor (e.g., the heat conduction plate 40 and the heat conduction sheet 41) made of a material higher in thermal conductivity than the bearing support (e.g., the bearing insertion portion 84 of the back plate 80B) that supports the bearing (e.g., the agitation bearing 76). The heat conductor includes a heat absorbing portion (e.g., the heat absorber 40a and the heat conduction sheet 41) to contact the bearing and absorb heat from the bearing, and a heat dissipating portion (e.g., the heat dissipater 40b) to release the heat absorbed by the heat absorbing portion. The bearing includes an outer ring (e.g., the outer ring 73) secured to the bearing support, an inner ring (e.g., the inner ring 75) to rotate together with the rotation shaft, and a ball (e.g., the ball 74) disposed between the outer ring and the inner ring. The heat conductor is disposed to contact the outer ring of the bearing and disengaged from the inner ring and the ball.

It is to be noted that the developer conveyor including the rotation shaft is not limited to a screw but can be an auger or a paddle.

According to Aspect A, as described above, since the heat conductor does not contact the inner ring of the bearing, the number of portions heated by the friction is reduced compared with a configuration in which the heat conductor contacts the inner ring, thereby generating frictional heat. With this configuration, in the configuration using the rolling bearing for the developer conveyor, the amount of heat generated by the rotation of the developer conveyor is reduced. Accordingly, the developer conveyor is inhibited from being heated with the frictional heat, which arises as the developer conveyor rotates.

Aspect B

In Aspect A, the shaft (e.g., the agitation screw shaft 111) of the developer conveyor and the bearing (e.g., the agitation bearing 76) are made of metal.

Aspect B attains a heat conduction structure to efficiently conduct heat from the rotation shaft via the bearing to the heat conductor (e.g., the heat conduction plate 40).

Aspect C

The developing device according to Aspect A or B further includes a seal (e.g., the agitation seal 77) to contact the shaft (e.g., the agitation screw shaft 111) at a position inner than the bearing (e.g., the agitation bearing 76) in the axial direction to seal a developer passage (e.g., the agitation compartment 10) through which the developer moves from inside the developer container to the bearing.

This configuration can inhibit the developer from inhibiting the rotation of the developer conveyor such the agitation screw 11. Additionally, even when frictional heat is generated in the contact portion between the seal and the rotation shaft, the heat conductor (e.g., the heat conduction plate 40 and the heat conduction sheet 41) release the heat via the rotation shaft and the bearing. Accordingly, the developer conveyor is inhibited from being heated with the frictional heat, which arises as the developer conveyor rotates.

In particular, the rotation shaft and the bearing both made of metal enhance the thermal conductivity of the components to provide a route of heat conduction from the contact portion between the seal and the rotation shaft to the heat conductor. Accordingly, the frictional heat caused between the seal and the rotation shaft is released efficiently.

Aspect D

In any one of Aspects A through C, the heat conductor (e.g., the heat conduction plate 40 and the heat conduction sheet 41) includes an elastic body (e.g., the heat conduction sheet 41) disposed in the contact portion with the outer ring, and the elastic body is made of a material higher in thermal conductivity than the bearing support such as the back plate 80B.

As described above, this aspect can increase the area of contact between the heat conductor and the outer ring, thereby enhancing the thermal conductivity from the bearing to the heat conductor.

Aspect E

In any one of Aspects A through D, the heat conductor (e.g., the heat conduction plate 40 and the heat conduction sheet 41) is pressed to the outer ring to contact the outer ring.

Accordingly, the thermal conductivity from the bearing to the heat conductor is enhanced.

Aspect F

In any one of Aspects A through E, the heat conductor (e.g., the heat conduction plate 40 and the heat conduction sheet 41) includes an exposed portion (e.g., the heat dissipater 40b) disposed outside the developing device, and the exposed portion has a projection.

Accordingly, the surface area of the heat dissipating part of the heat conductor is increased, thereby enhancing the cooling effect.

Aspect G

In any one of Aspects A through E, the heat conductor (e.g., the heat conduction plate 40 and the heat conduction sheet 41) includes an exposed portion (e.g., the heat dissipater 40b) disposed outside the developing device, and a metal part having a projection is disposed in the exposed portion.

This aspect can increase the surface area of the heat conductor to release heat from the heat conductor to the outside of the developing device, thereby enhancing the cooling effect.

Aspect H

In any one of Aspects A through G, the heat conductor (e.g., the heat conduction plate 40 and the heat conduction sheet 41) includes an exposed portion (e.g., the heat dissipater 40b) disposed outside the developing device, and the exposed portion serves as a wall face of a cooling channel (e.g., the cooling channel R) through which cooling air or cooling gas flows.

With this aspect, as described in the embodiments, the airflow promotes the release of heat from the exposed portion of the heat conductor, thereby enhancing the effect to inhibit the temperature rise of the developer conveyor such as the agitation screw 11.

Aspect I

In any one of Aspects A through G, the heat conductor (e.g., the heat conduction plate 40 and the heat conduction sheet 41) includes an exposed portion (e.g., the heat dissipater 40b) disposed outside the developing device, and the exposed portion serves as a wall face of a cooling channel (e.g., the cooling channel R) through which cooling liquid such as radiator liquid flows.

With this aspect, as described in the embodiments, the flow of liquid promotes the release of heat from the exposed portion of the heat conductor, thereby enhancing the effect to inhibit the temperature rise of the developer conveyor such as the agitation screw 11.

Aspect J

In an image forming apparatus, such as the image forming apparatus 500, that includes a latent image bearer (e.g., the photoconductor 1) and a developing device to develop the latent image on the latent image bearer, the developing device according to any of aspects A through I is used.

Accordingly, the image forming apparatus can inhibit the occurrence of image failure such as white lines, spots, and white spots as described above.

Numerous additional modifications and variations are possible in light of the above teachings. It is therefore to be understood that, within the scope of the appended claims, the disclosure of this patent specification may be practiced otherwise than as specifically described herein.

What is claimed is:

1. A developing device comprising:
a developer bearer to bear developer;
a casing including a bearing support and a developer container to contain the developer;
a developer conveyor to transport, by rotation, the developer in the developer container, the developer conveyor including a shaft;
a bearing to fit in the bearing support of the casing and support the shaft of the developer conveyor rotatably on the casing, the bearing including
an outer ring secured to the bearing support,
an inner ring to rotate together with the shaft of the developer conveyor, and
a ball disposed between the outer ring and the inner ring; and
a heat conductor made of a material higher in thermal conductivity than the bearing support and disposed to contact the outer ring of the bearing and contactless with the inner ring and the ball, the heat conductor including
a heat absorbing portion to contact the bearing and absorb heat from the bearing, and
a heat dissipating portion to release the heat absorbed by the heat absorbing portion.

2. The developing device according to claim 1, wherein the shaft of the developer conveyor and the bearing are made of metal.

3. The developing device according to claim 1, further comprising a seal to contact the shaft of the developer conveyor at a position inner than the bearing in an axial direction of the developer conveyor,
wherein the seal seals a developer passage oriented to the bearing from inside the developer container.

4. The developing device according to claim 1, wherein the heat conductor comprises an elastic body disposed to contact the outer ring and made of the material higher in thermal conductivity than the bearing support.

5. The developing device according to claim 1, wherein the heat conductor is in tight contact with the outer ring.

6. The developing device according to claim 5, further comprising a pressing member to secure the heat conductor to the casing and press the heat conductor against the outer ring.

7. The developing device according to claim 1, wherein the heat conductor comprises an exposed portion exposed outside the developing device, and
the exposed portion includes a projection.

8. The developing device according to claim 1, further comprising a metal part including a projection,
wherein the heat conductor includes an exposed portion exposed outside the developing device, and
the metal part is disposed on the exposed portion.

9. The developing device according to claim 1, wherein the heat conductor comprises an exposed portion exposed outside the developing device, and
the exposed portion serves as a wall face of a cooling channel through which cooling air flows to cool the heat conductor.

10. The developing device according to claim 1, wherein the heat conductor comprises an exposed portion exposed outside the developing device, and
the exposed portion serves as a wall face of a cooling channel through which cooling liquid flows to cool the heat conductor.

11. An image forming apparatus comprising:
a latent image bearer to bear a latent image; and
the developing device according to claim 1 to develop the latent image on the latent image bearer with the developer.
